(19) United States
(12) Patent Application Publication
(10) Pub. No.: US 2026/0056406 A1
(43) Pub. Date: Feb. 26, 2026

(54) OPTICAL SYSTEM FOR LIGHTGUIDE-BASED DISPLAYS

(71) Applicant: LUMUS LTD., Ness Ziona (IL)

(72) Inventor: Yochay DANZIGER, Kfar Vradim (IL)

(21) Appl. No.: 19/131,240

(22) PCT Filed: May 16, 2024
(86) PCT No.: PCT/IL2024/050483

§ 371 Date: May 20, 2025

Related U.S. Application Data
(60) Provisional application No. 63/467,063, filed on May 17, 2023.

(51) Int. Cl. G02B 27/01

(52) U.S. Cl. CPC G02B 27/0101

(57) ABSTRACT

An optical system includes a prism (36) having a planar input surface (38, 44a, 44b, 54) for injection of a laser beam, the prism integrated with a lightguide (10, 220). A fast-scanning mirror (32) is deployed in facing relation to a scanner interface surface (12) of the prism. A laser beam introduced via the input surface passes through the prism and the scanner interface surface, impinging on the fast-scanning mirror to generate a scanned reflected beam that scans an angular field of view, passing through the prism so as to enter the lightguide. One side of the lightguide entrance aperture has an optical cutoff edge (24a) that trims an edge of the scanned reflected beam for both a first beam direction (102) at a first extremity of the angular field of view and for a second beam direction (104) at a second extremity of the angular field of view.

### FIELD AND BACKGROUND OF THE INVENTION

The present invention relates to optical systems and, in particular, it concerns lightguide-based displays with injection of a scanning laser beam.

It is known to employ transparent lightguides for conveying an image in front of a viewer by internal reflection within the lightguide and coupling-out the image towards the eye of the view, for viewing in combination with a view of a real scene. One particularly compact option for injecting an image into a lightguide is to employ a laser beam which is modulated synchronously with a scanning motion to generate an image. The beam of a scanning laser image generator can in principle be injected directly into a lightguide. However, it is difficult to achieve compactness, ergonomic design, and efficiency with such an arrangement.

### SUMMARY OF THE INVENTION

The present invention is an optical system employing injection of a scanned laser beam into a lightguide.

According to the teachings of an embodiment of the present invention there is provided, an optical system comprising: (a) a lightguide formed from transparent material and having a pair of mutually parallel surfaces for supporting propagation of light within the lightguide by internal reflection at the pair of surfaces; (b) a prism optically integrated with the lightguide, the prism having a planar input surface for injection of a laser beam and a planar scanner interface surface; and (c) a fast-scanning mirror in facing relation to the scanner interface surface, the fast scanning mirror performing a scanning motion about at least one axis, wherein the prism and the fast-scanning mirror are arranged such that a laser beam introduced via the input surface passes through the prism and exits from the scanner interface surface so as to impinge on the fast-scanning mirror to generate a scanned reflected beam that scans an angular field of view, the scanned reflected beam reentering the scanner interface surface and passing through the prism so as to enter the lightguide at a lightguide entrance aperture, and wherein at least one side of the lightguide entrance aperture has an optical cutoff edge that trims an edge of the scanned reflected beam for both a first beam direction at a first extremity of the angular field of view and for a second beam direction at a second extremity of the angular field of view.

According to a further feature of an embodiment of the present invention, the prism further comprises a mirror surface for reflecting the laser beam introduced via the input surface towards the scanner interface surface.

According to a further feature of an embodiment of the present invention, the mirror surface is coplanar with one of the parallel surfaces of the lightguide.

According to a further feature of an embodiment of the present invention, the prism further comprises a redirecting mirror deployed to redirect the laser beam introduced via the input surface towards the mirror surface.

According to a further feature of an embodiment of the present invention, the mirror surface is non-parallel to the parallel surfaces of the lightguide, and wherein the mirror surface meets one of the parallel surfaces at the optical cutoff edge.

According to a further feature of an embodiment of the present invention, the optical cutoff edge is deployed to trim an edge of the laser beam prior to impinging on the fast-scanning mirror.

According to a further feature of an embodiment of the present invention, the fast-scanning mirror is configured to perform a scanning motion about two perpendicular axes.

According to a further feature of an embodiment of the present invention, the lightguide has a second pair of mutually parallel surfaces perpendicular to the pair of mutually parallel surfaces thereby forming a lightguide with a rectangular cross-sectional shape supporting propagation of the scanned reflected beam through four-fold internal reflection.

### BRIEF DESCRIPTION OF THE DRAWINGS

The invention is herein described, by way of example only, with reference to the accompanying drawings, wherein:

FIG. 1 is a schematic side view of a fast-scanning mirror injecting a scanning beam into a lightguide illustrating the geometrical considerations for positioning of the mirror relative to the lightguide;

FIG. 2 is a schematic side view of an optical system employing injection of a scanned laser beam into a lightguide according to a first embodiment of the present invention;

FIG. 3 is a schematic side view of an optical system employing injection of a scanned laser beam into a lightguide according to a second embodiment of the present invention;

FIG. 4 is a schematic side view of an optical system employing injection of a scanned laser beam into a lightguide according to a third embodiment of the present invention;

FIG. 5 is a schematic side view of an optical system employing injection of a scanned laser beam into a lightguide according to a fourth embodiment of the present invention;

FIG. 6 is a schematic overview of a display implemented using an optical system according to one of the above embodiments; and

FIGS. 7A and 7B are schematic isometric views illustrating use of a fast-scanning mirror to scan a laser beam in two dimensions for introduction into a rectangular cross-section lightguide, where FIG. 7A illustrates a scanning motion in an X-Y plane (about a Z axis) and FIG. 7B illustrates a scanning motion in a Y-Z plane (about an X axis).

### DESCRIPTION OF THE PREFERRED EMBODIMENTS

The present invention is an optical system employing injection of a scanned laser beam into a lightguide.

The principles and operation of optical systems according to the present invention may be better understood with reference to the drawings and the accompanying description.

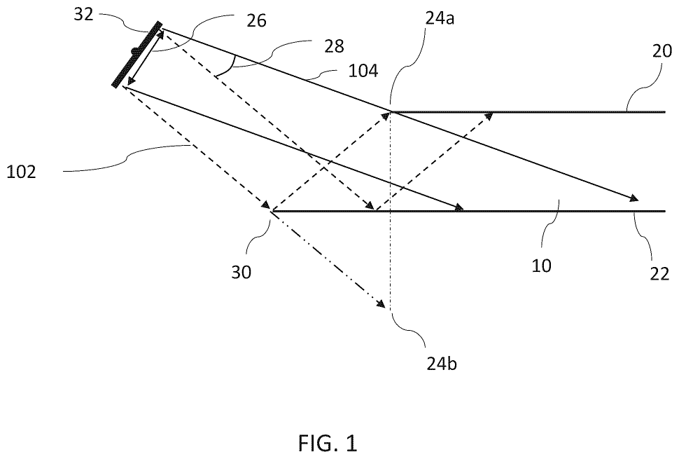

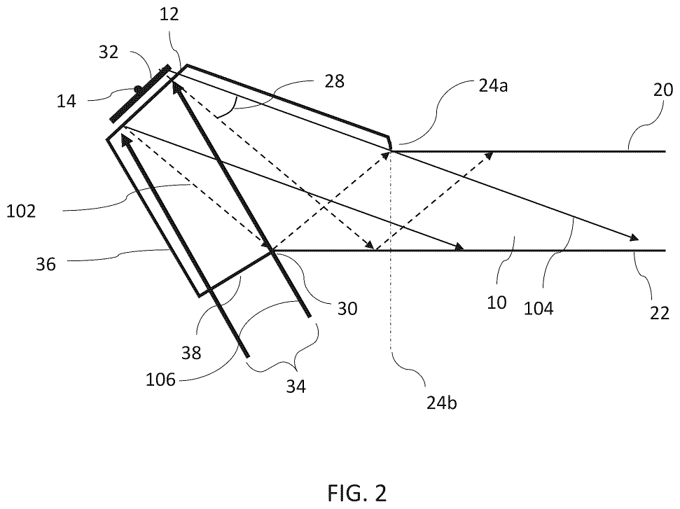

Referring now to the drawings, FIG. 1 illustrates various geometrical considerations for implementation of while FIGS. 2-7B illustrate various aspects of an optical system, and a display employing such a system, with injection of a scanned laser beam into a lightguide. In general terms, the optical system includes a lightguide 10 formed from transparent material and having a pair of mutually parallel surfaces 20, 22 for supporting propagation of light within the lightguide by internal reflection at the pair of surfaces. A prism 36, optically integrated with lightguide 10, has a planar input surface 38 for injection of a laser beam 34 and a planar scanner interface surface 12. A fast-scanning mirror 32, deployed in facing relation to the scanner interface surface 12, performs a scanning motion about at least one axis 14.

Prism 36 and fast-scanning mirror 32 are arranged such that laser beam 34 introduced via input surface 38 passes through prism 36 and exits from scanner interface surface 12 so as to impinge on fast-scanning mirror 32, thereby generating a scanned reflected beam 102, 104 that scans an angular field of view 28. The scanned reflected beam reenters scanner interface surface 12 and passes through prism 36 so as to enter lightguide 10 at a lightguide entrance aperture 24a-24b.

According to certain particularly preferred implementations of the present invention, one side of the lightguide entrance aperture has an optical cutoff edge 24a that trims an edge of the scanned reflected beam for both a first beam direction 102 at a first extremity of the angular field of view and for a second beam direction 104 at a second extremity of the angular field of view.

The optical systems described herein offer significant advantages particularly in relation to near-eye displays, where they facilitate compact and ergonomic implementations. In certain particularly preferred cases, no hardware protrudes in front of the lightguide. Additional considerations which are addressed by certain of the optical systems disclosed herein include injection of beams into the lightguide via surfaces which are roughly perpendicular to the beam direction so as to minimize chromatic dispersion in beams that are not monochromatic.

It is also preferable that a laser beam scanning geometry be configured so that the angle between the incident beam and a normal to the scanning mirror is a minimum. In order to achieve this, it is preferable that the scanner be located as far as possible from the entrance to the lightguide without degrading beam quality or causing vignetting of the scanned beam. FIG. 1 shows a schematic cross-section of a lightguide where the scanning mirror 32 is placed at the furthest distance without compromising performance.

By way of one non-limiting specific example, lightguide 10 has 1.25 mm thickness between the parallel surfaces 20 and 22 that guide the light through total internal reflection (TIR). The lightguide has entrance aperture is defined between edge 24a and a virtual image of this point reflected in surface 22 as indicated at 24b. For clarity, this entrance prism is not shown, but the beams are assumed to be within the refracting material of the coupling prism into the lightguide. In the subsequent figures, a limiting envelope of prism 36 is shown. The laser beam is assumed to have width 26 of 1 mm and the field of view (FOV) across which the beam scans between direction 102 and direction 104 corresponding to angle 28 is assumed to be 20 degrees (within the coupling prism). The upper beam of the field is shown as two parallel solid arrows and the lowest beam as dashed parallel arrows 102. The lower face 22 of the lightguide is extended until point 30 so that the lowest beam of the field (dashed arrow 102) aimed at virtual point 24b (where a virtual continuation of the beam is shown as a dash-dot-dot-dash arrow), is reflected onto 24a and thus enters the lightguide.

The arrangement of FIG. 1 illustrates a maximum distance of the scanning mirror from the lightguide entrance which can be achieved for a given field of view, size of mirror and thickness of lightguide without loss of light through vignetting. In this case, the uppermost ray of the beam corresponding to the upper extremity of the field (solid arrow) 104 is aimed at 24a and the lowermost ray of the beam corresponding to the lower extremity of the field (dashed arrow 102) is aimed at 24b.

FIG. 2 shows a device architecture based on the geometry of FIG. 1 illustrating an injected beam 34. The envelope shows the limiting volume of prism 36 used for this configuration. Beam 34 enters prism 36 perpendicular to surface 38, thereby minimizing dispersion. Input surface 38 is located beyond edge 30 so that reflection of the scanned beam (dashed arrow 102) is not perturbed.

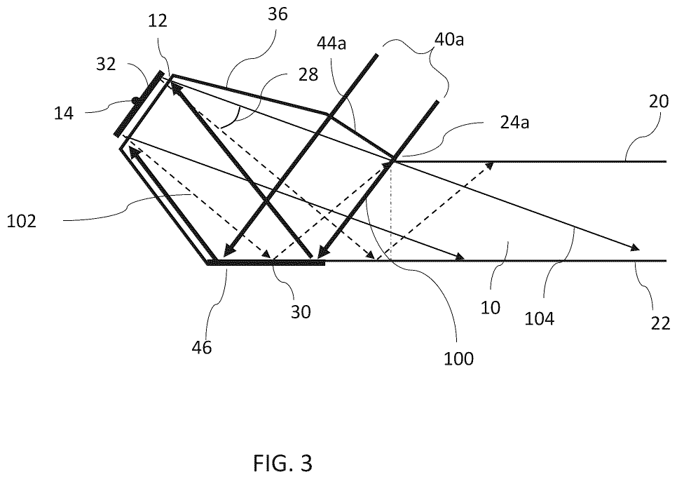

The arrangement of FIG. 2 provides a highly compact and efficient optical system for implementing a display. However, it requires the scanning mirror and associated actuators (not shown) to be located outside the thickness of the lightguide on one side and the laser illumination arrangement to be located outside the thickness of the lightguide on the other side. This may not be an optimal architecture for near-eye displays, where it is typically preferred to have the device free from components on the outside of the lightguide. A number of alternative configurations, exemplified with reference to FIGS. 3-5, employ a prism 36 which includes at least one mirror surface (reflective coating) 46 for reflecting the laser beam introduced via the input surface towards the scanner interface surface 12.

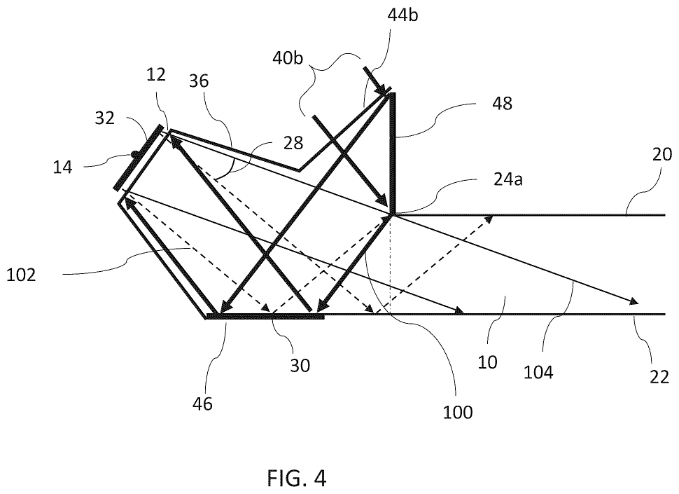

In the examples of FIGS. 3 and 4, mirror surface 46 is parallel to, and typically coplanar with, one of the parallel surfaces 22 of lightguide 10. In the case of FIG. 3, the architecture is optically equivalent to that of FIG. 2, but here the incident beam 40a enters the prism 42a through an input surface 44a (perpendicular to the beam) that is adjacent to 24a so as not to disrupt coupling of the scanned laser beams into the lightguide. Beam 40a reflects from mirror surface 46 due to a reflective coating (dielectric or metallic) that here extends slightly beyond point 30. The reflective coating is needed if the beam impinges on surface 22 at an angle of incidence smaller than the critical angle, therefore not providing total internal reflection. The reflected beam impinges on fast-scanning mirror 32 at an angle as close as possible to perpendicular while being outside the angular FOV of the reflected scanning laser beam.

The configuration of FIG. 3 may be advantageous over that of FIG. 2 in that both the scanning mirror and the laser optics are located on one side of the lightguide, thereby allowing an implementation in which nothing projects outwards from the outside of the lightguide, suitable for an ergonomic implementation in a glasses-frame form factor or the like. However, the outward-angled laser beam injection direction may impose design limitations not ideal for all applications. FIG. 4 illustrates a further variant implementation employing an additional redirecting mirror 48 deployed to redirect the laser beam 40b introduced via the input surface 44b towards mirror surface 46. Redirecting mirror 48 is located so as not to compromise the reflective properties of lightguide surface 20 beyond edge 24a, and optionally may meet lightguide surface 20 at edge 24a to define an optical cutoff edge. Depending on the angles chosen for injection of the laser beam and for redirecting mirror 48, the redirecting mirror may rely on TIR or may also require a dielectric or metallic mirror coating. The remainder of the light path and the operation of the optical system are identical to that of FIG. 3.

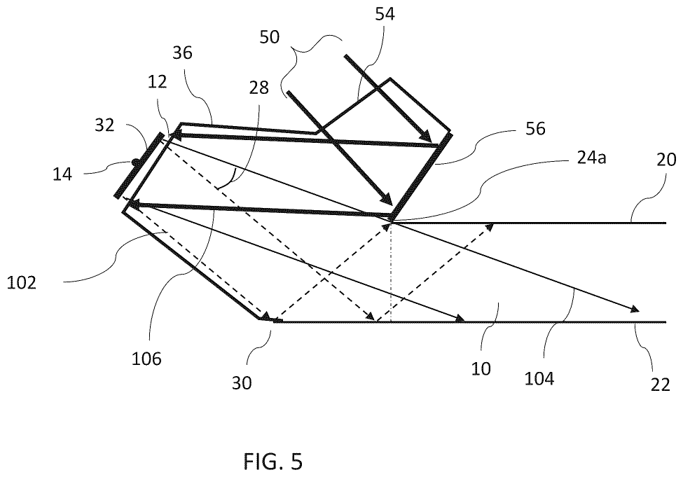

FIG. 5 illustrates a further variant implementation in which a single mirror surface 56 is non-parallel to the lightguide surfaces and redirects the injected laser beam 50 towards scanner interface surface 12 from the same side of the lightguide as the fast-scanning mirror is located, and without crossing the path of the reflected scanning laser beams. Laser beam 50 is injected perpendicular to an input surface 54 before being reflected at mirror surface 56 towards fast scanning mirror 32. Mirror surface 56 may advantageously intersect lightguide surface 20 at optical cutoff edge 24a. Thus, both in the cases of FIG. 4 and FIG. 5, optical cutoff edge 24a may be deployed to trim an edge of the laser beam 40b, 50 prior to impinging on the fast-scanning mirror 32. The geometry is preferably designed such that the direction of beam injection is as an incident angle less than the critical angle relative to lightguide surface 22 so that any light from the injected light beam that is “trimmed” by (i.e., falls to the left of) edge 24a will escape from the lightguide at surface 22.

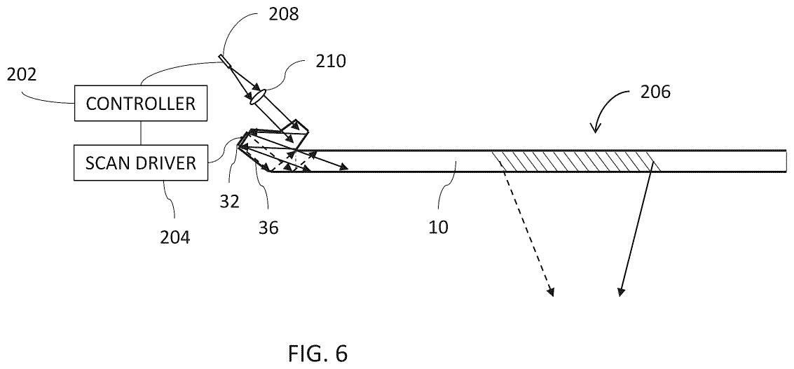

FIG. 6 provides a schematic overview of the optical systems of the present invention incorporated into a display. The display is illustrated arbitrarily with the embodiment of FIG. 5 but is equally applicable to all of the embodiments described above. Lightguide 10 is shown here extended so as to convey the image light by internal reflection in front of the eye of the viewer where it is coupled out towards the eye of the viewer by a coupling out arrangement 206, which may be a set of internal partial reflectors (as illustrated here) or a diffractive optical element, all as is known in the art.

The input beam for injection into the scanning arrangement is typically generated by a laser source 208 with collimating optics 210 to form a collimated beam. Fast scanning mirror 32 is operated by associated components shown here schematically as scan driver 204, typically including piezo-electric actuators and corresponding driver circuitry. Modulation of the laser intensity is varied synchronously with the scanning motion according to image data by a suitable controller 202, all as is known in the art.

For a color image, laser beams of three primary colors (e.g., RGB) may be combined into a single beam using dichroic combiners and are then independently modulated synchronously with the scanning motion to generate a color image. Alternatively, scanning may be performed for a “vector” of side-by-side laser beams from closely spaced sources of different colors. In the latter case, the side-by-side beams are arranged to converge towards the scanning mirror at slightly different angles, and therefore instantaneously illuminate different pixels of the image. A corresponding offset is used when modulating the beams synchronously according to the scanning pattern.

The illustrations thus far all show only one dimension of the scanning pattern. In order to generate a two-dimensional image, fast scanning mirror 32 may be driven in a scanning pattern about two perpendicular axes, as is known in the art. Alternatively, multiple illumination sources may be used for the dimension into the page of the above drawings, with each illumination source providing one row of pixels in the generated image.

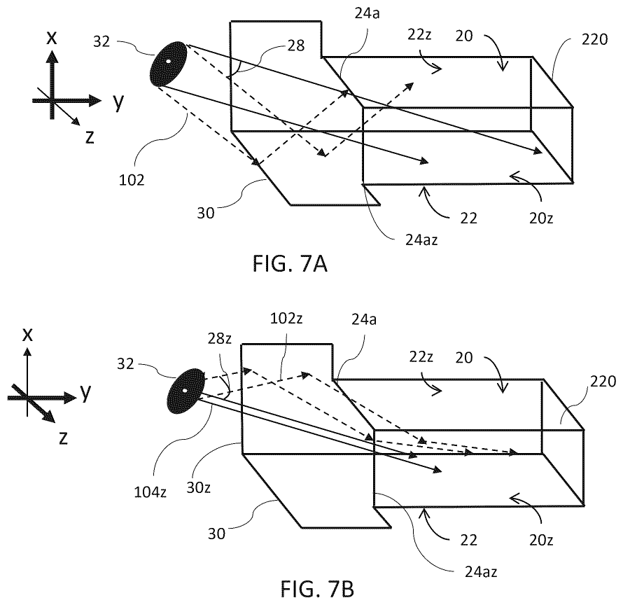

The arrangements illustrated thus far may be used to inject an image directly into a slab-type lightguide 10 but can also be employed with a rectangular cross-section lightguide such as those described in PCT publication WO 2018/065975 A1. FIGS. 7A and 7B illustrate schematically the geometry of such an option for injecting an image into a rectangular cross-section lightguide 220, which has a second pair of mutually parallel surfaces 20z, 22z perpendicular to the first pair of mutually parallel surfaces 20, 22 thereby forming a lightguide with a rectangular cross-sectional shape supporting propagation of the scanned reflected beam through four-fold internal reflection.

Such an implementation may be described as a combination of two dimensions where each dimension is equivalent to one of the embodiments described above. FIG. 7A illustrates the scanning motion in an XY plane (about the Z axis) equivalent to that described in FIG. 1, with all markings similar to those of FIG. 1. The scanning mirror is shown here as being circular, but a rectangular shape may also be used. FIG. 7B shows the scanning motion in a YZ plane (about the X axis), which is also equivalent to the geometry of FIG. 1, with equivalent markings including a ‘z’suffix.

Details of the prism structure and beam injection geometry are omitted here due to the difficulty in illustrating the prism structures clearly in isometric view, but the prism may be implemented according to the principles described and illustrated above, where the top view and the side view can each be implemented according to any of the options of FIGS. 2-5.

It will be appreciated that the above descriptions are intended only to serve as examples, and that many other embodiments are possible within the scope of the present invention as defined in the appended claims.

What is claimed is:

1. An optical system comprising:
(a) a lightguide formed from transparent material and having a pair of mutually parallel surfaces for supporting propagation of light within said lightguide by internal reflection at said pair of surfaces;
(b) a prism optically integrated with said lightguide, said prism having a planar input surface for injection of a laser beam and a planar scanner interface surface; and
(c) a fast-scanning mirror in facing relation to said scanner interface surface, said fast scanning mirror performing a scanning motion about at least one axis,
wherein said prism and said fast-scanning mirror are arranged such that a laser beam introduced via said input surface passes through said prism and exits from said scanner interface surface so as to impinge on said fast-scanning mirror to generate a scanned reflected beam that scans an angular field of view, said scanned reflected beam reentering said scanner interface surface and passing through said prism so as to enter said lightguide at a lightguide entrance aperture,
and wherein at least one side of said lightguide entrance aperture has an optical cutoff edge that trims an edge of the scanned reflected beam for both a first beam direction at a first extremity of said angular field of view and for a second beam direction at a second extremity of said angular field of view.

2. The optical system of claim 1, wherein said prism further comprises a mirror surface for reflecting the laser beam introduced via said input surface towards said scanner interface surface.

3. The optical system of claim 2, wherein said mirror surface is coplanar with one of said parallel surfaces of said lightguide.

4. The optical system of claim 3, wherein said prism further comprises a redirecting mirror deployed to redirect the laser beam introduced via said input surface towards said mirror surface.

5. The optical system of claim 2, wherein said mirror surface is non-parallel to said parallel surfaces of said lightguide, and wherein said mirror surface meets one of said parallel surfaces at said optical cutoff edge.

6. The optical system of claim 1, wherein said optical cutoff edge is deployed to trim an edge of said laser beam prior to impinging on said fast-scanning mirror.

7. The optical system of claim 1, wherein said fast-scanning mirror is configured to perform a scanning motion about two perpendicular axes.

8. The optical system of claim 7, wherein said lightguide has a second pair of mutually parallel surfaces perpendicular to said pair of mutually parallel surfaces thereby forming a lightguide with a rectangular cross-sectional shape supporting propagation of said scanned reflected beam through four-fold internal reflection.
